(19) United States
(12) Patent Application Publication
(10) Pub. No.: US 2012/0183114 A1
(43) Pub. Date: Jul. 19, 2012

(54) METHOD AND APPARATUS FOR TESTING AN ANNULAR WELD ON A MAIN COOLANT LINE CONNECTED TO A REACTOR PRESSURE VESSEL OF A NUCLEAR POWER PLANT

(75) Inventors: BERND BISCHOFF, HEMHOFEN (DE); ROBERT STAUDIGEL, HOCHSTADT (DE)

(73) Assignee: AREVA NP GMBH, ERLANGEN (DE)

(21) Appl. No.: 13/300,837

(22) Filed: Nov. 21, 2011

Related U.S. Application Data
(63) Continuation of application No. PCT/EP2010/056549, filed on May 12, 2010.

(30) Foreign Application Priority Data
May 20, 2009 (DE) 10 2009 026 405.1

(51) Int. Cl. G21C 17/013; G21C 17/017

(52) U.S. Cl. 376/248; 376/249

(57) ABSTRACT

A method and an apparatus for test an annular weld at a main coolant line connected to a reactor pressure vessel in a nuclear power plant, include a self-propelled submersible vehicle which is introduced into an opened, flooded reactor pressure vessel. The submersible vehicle has at least one test device to be placed against an inner circumferential surface of the main coolant line and moved in circumferential direction of the main coolant line. The submersible vehicle is advanced into the main coolant line, which is also flooded, and is fixed in the region of the weld by radially deployable spreading or extension arms. The test device is then placed against the weld and is moved therealong in the circumferential direction.

### CROSS-REFERENCE TO RELATED APPLICATION

This is a continuation, under 35 U.S.C. §120, of copending International

Application No. PCT/EP2010/056549, filed May 12, 2010, which designated the United States; this application also claims the priority, under 35 U.S.C. §119, of German Patent Application DE 10 2009 026 405.1, filed May 20, 2009; the prior applications are herewith incorporated by reference in their entirety.

### BACKGROUND OF THE INVENTION

Field of the Invention

The invention relates to a method and an apparatus for testing an annular weld on a main coolant line connected to a reactor pressure vessel of a nuclear power plant.

In order to ensure operational reliability of a nuclear reactor, it is necessary among other things to inspect the annular welds of a main coolant line connected to a reactor pressure vessel using methods of non-destructive material testing. In the course of such an inspection, insulation material surrounding the main coolant line is removed therefrom and the welds are tested from the outside using suitable test manipulators. The main coolant lines, however, have become highly radioactive, depending on the time during which they have been in operation. For that reason, additional protection zones provided with lead screens need to be established in order to protect the operating staff carrying out the material testing and the mounting of the test instruments necessary therefor. Despite those protection zones, direct exposure to radioactivity, which leads to high dose exposure or uptake of the operating staff, cannot be completely avoided.

### SUMMARY OF THE INVENTION

It is accordingly an object of the invention to provide a method and an apparatus for testing an annular weld on a main coolant line connected to a reactor pressure vessel of a nuclear power plant, which overcome the hereinafore-mentioned disadvantages of the heretofore-known methods and apparatuses of this general type and in which a dose to which operating staff are exposed is significantly lower than for known methods.

With the foregoing and other objects in view there is provided, in accordance with the invention, a method for testing an annular weld of a main coolant line connected to a reactor pressure vessel of a nuclear power plant. The method comprises providing a self-propelled submersible vehicle having ends and test devices each disposed at a respective one of the ends for positioning at an inner circumferential surface of the main coolant line and movement in circumferential direction of the main coolant line. The submersible vehicle is introduced into an opened and flooded reactor pressure vessel. The submersible vehicle is guided into a flooded main coolant line. The submersible vehicle is fixed in vicinity of a weld by using radially deployable spreading arms. Subsequently, one of the test devices is positioned at the weld and the test device is moved along the weld in circumferential direction.

Due to the use of a submersible vehicle which carries a test device and can be guided into the main coolant line, the weld can be tested or inspected from the inside in such a way that the external test, which exposes staff to dose exposure and is carried out in the prior art, is no longer necessary.

When a submersible vehicle is used in which the at least one test device is disposed at an end side and the submersible vehicle is fixed for testing a weld which is used to weld the end sides of an elbow-shaped section of the main coolant line to a linear section of the main coolant line, with the spreading arms in the linear section of the main coolant line in such a way that its end side that includes the test device faces the weld, it is possible to test welds particularly simply and quickly in the region of a pipe elbow. This is because the submersible vehicle can be fixed in the linear section of the main coolant line in such a way that its central longitudinal axis is aligned at least approximately coaxially with the central axis of the linear section and thus also with the central axis of the annular weld. As a result, the movement of the test device which is necessary for carrying out the test is simplified because the test device, once it is positioned onto the weld, only needs to be rotated about the central longitudinal axis of the submersible vehicle and only needs to be moved, if at all, additionally in the radial direction if the central longitudinal axis is not aligned exactly coaxially with the central axis of the ideally annular weld or if the annular weld is not exactly circular.

It is particularly advantageous to use a submersible vehicle in which a test device is disposed at each end side. In this way it is possible to test, in just a single underwater operation, both annular welds, with which the end sides of an elbow-shaped section are in each case welded to a linear section of the main coolant line. In other words, the test device, which is disposed at the leading end side in the direction of travel, can be used to test the weld located in front of the submersible vehicle, and the test device disposed at the trailing end side can be used to test the weld which is situated behind the submersible vehicle once it has traveled through the elbow-shaped section, with the submersible vehicle in either case being anchored in a linear section. As a result, the overall duration of the test is additionally shortened because a submersible vehicle, in which the test device is disposed only at one end side, once it has traveled through the main coolant line, must be completely guided back, turned around and again guided into the main coolant line.

With the objects of the invention in view, there is concomitantly provided an apparatus for testing annular welds of a main coolant line connected to a reactor pressure vessel of a nuclear power plant. The apparatus comprises a self-propelled submersible vehicle having a base body and end sides, a plurality of radially deployable spreading arms disposed at the base body for fixing the submersible vehicle in the main coolant line, and test devices each disposed at a respective one of the end sides of the submersible vehicle. The test devices are configured to be positioned at an inner circumferential surface of the main coolant line and to be moved in circumferential direction of the main coolant line.

Other features which are considered as characteristic for the invention are set forth in the appended claims.

Although the invention is illustrated and described herein as embodied in a method and an apparatus for testing an annular weld on a main coolant line connected to a reactor pressure vessel of a nuclear power plant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, longitudinal-sectional view of an opened reactor pressure vessel and main coolant lines connected thereto, with a submersible vehicle according to the invention located in a main coolant line; and

FIG. 2 is an enlarged, fragmentary, longitudinal-sectional view of a region of a pipe elbow in which the submersible vehicle according to the invention is situated in a test position at a weld.

### DETAILED DESCRIPTION OF THE INVENTION

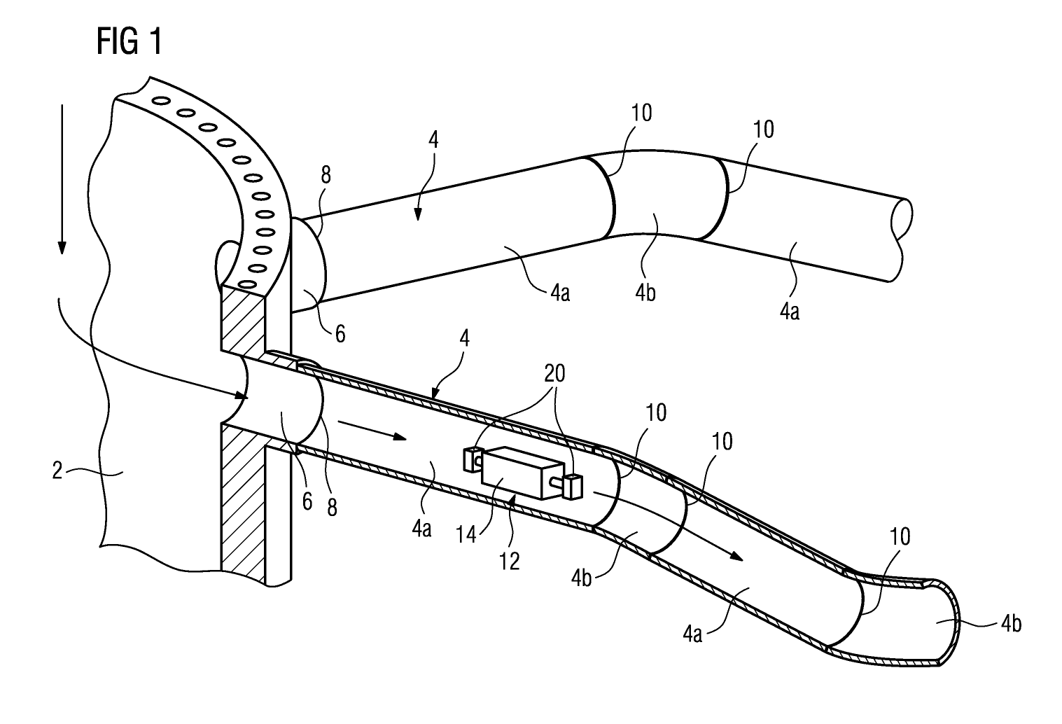

Referring now to the figures of the drawings in detail and first, particularly, to FIG. 1 thereof, there is seen a plurality of main coolant lines 4 which open into a reactor pressure vessel 2 of a nuclear power plant. These main coolant lines 4 are each welded to a respective connecting piece 6 of the reactor pressure vessel 2 with an annular weld 8 and are assembled from a plurality of respective linear and elbow-shaped sections 4a and 4b. The elbow-shaped sections 4b have end sides each being welded to an end side of a respective linear section 4a with an annular weld 10.

A self-propelled submersible vehicle 12 is introduced into the flooded reactor pressure vessel 2. The submersible vehicle 12 is guided into a likewise flooded main coolant line 4 starting from the interior chamber of the reactor pressure vessel 2. The submersible vehicle 12 is advanced inside the main coolant line 4 using remote control. The submersible vehicle 12 includes a base body 14 with non-illustrated drive assemblies for remote-controlled maneuvering of the submersible vehicle 12 under water and a diagrammatically-illustrated test device 20 at each of its end sides. The submersible vehicle 12 is additionally connected, by a non-illustrated electric line, to a supply unit through which the submersible vehicle 12 is supplied with energy and through which control signals and measurement signals are transmitted from the supply unit to the submersible vehicle 12 or from the submersible vehicle 12 to the supply unit.

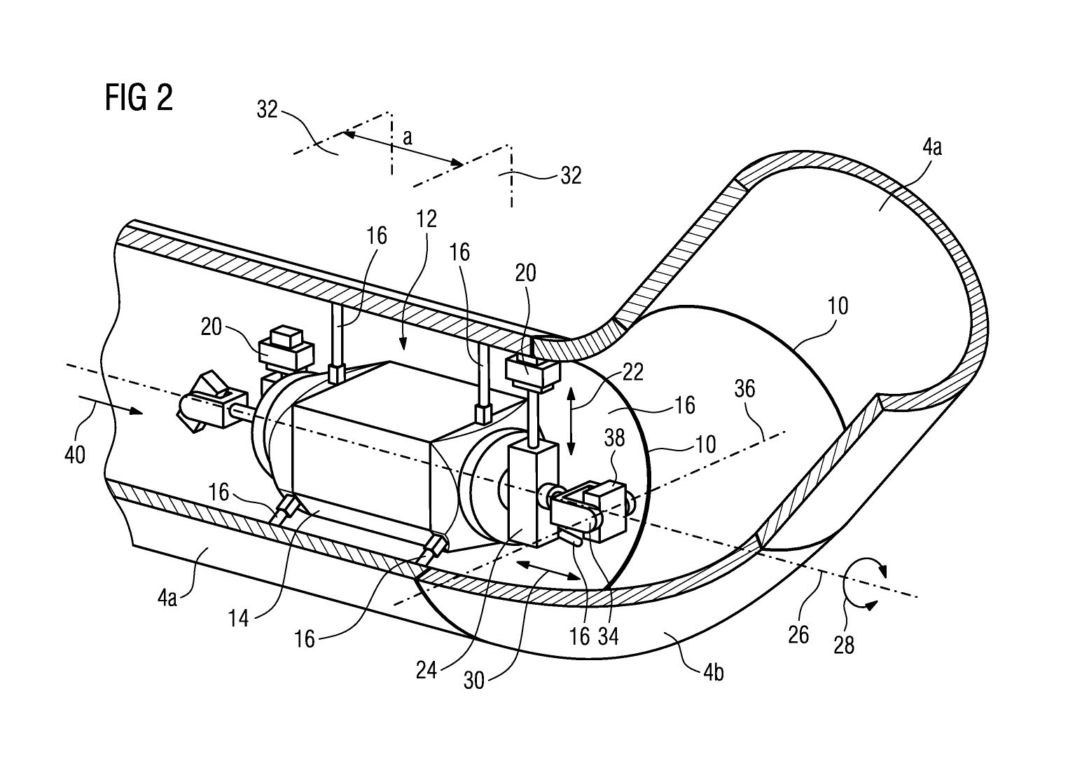

FIG. 2 shows the submersible vehicle 12 in a test position at one of the annular welds 10, with which a linear section 4a is welded to an elbow-shaped section 4b. To this end, the submersible vehicle 12 is moved into a position in which the base body 14 is still in the linear section 4a of the main coolant line 4. In this position, the submersible vehicle 12 is braced by using a plurality of radially deployable or extensible spreading arms 16, which are positionable onto an inner surface of the main coolant line 4. In this way, the submersible vehicle 12 is approximately centrally positioned and fixed in the region of the weld 10, that is to say with its central longitudinal axis 26 at least approximately coaxial with the central axis of the linear section 4a of the main coolant line 4. The positioning is carried out in such a way that one of the end sides of the submersible vehicle 12 that includes the test device 20 faces the weld 10 and is positioned so close to the weld 10 that the test device 20 can be positioned onto the weld 10.

The test devices 20, which are disposed at each end side of the submersible vehicle 12, are for example ultrasound probes, laser profilometers or eddy current probes, with which a destruction-free testing of the weld 10 can be carried out. Each test device 20 is mounted radially, that is to say perpendicularly with respect to the central longitudinal axis 26, in a holder 24. The holder 24 is mounted on the base body 14 in such a manner that it is rotatable about the central longitudinal axis 26 of the submersible vehicle 12 in the direction of a double-headed arrow 28 and in such a way that it is moveable or deployable in the direction of a double-headed arrow 22. The holder 24 is also mounted on the base body 14 in such a way that it is axially moveable in the direction of the central longitudinal axis 26, as is shown in FIG. 2 by way of a double-headed arrow 30. In this manner, the test device 20 can be positioned, with the submersible vehicle 12 fixed in the linear section 4a, precisely at the weld 10 and can be moved along the weld 10 in the circumferential direction thereof by rotating the holder about the central longitudinal axis 26.

The spreading arms 16 are disposed in two spread planes 32 which are mutually spaced-apart (by a spacing a). The spread planes 32 are orientated in such a way that they are perpendicular with respect to the central longitudinal axis 26, are indicated in the figure by way of dot-dash lines and are each located in the region of a respective end side. As a result, sufficient stability against tilting of the submersible vehicle 12 during testing is ensured. A fork-shaped bearing 34 for an inspection camera 38, which is also disposed at the holder 24, is mounted in such a way that it can pivot about a pivot axis 36 which is orientated perpendicularly with respect to the central longitudinal axis 26. The inspection camera 38 can be used to visually observe a test operation.

After the completed testing of a weld 10, which connects the linear section 4a to the pipe elbow 4b, and is in front of the submersible vehicle 12, as viewed in a direction 40 of travel, by using the test device 20 which is disposed at a leading end side (likewise viewed in the direction 40 of travel), the spreading arms 16 are retracted. Subsequently, the submersible vehicle 12 is guided through the elbow-shaped section 4b into the next linear section 4a, to a position in which the weld 10, with which the elbow-shaped section 4b is welded to the linear region 4a disposed therebehind when viewed in the direction 40 of travel, can be tested with the test device 20 which is disposed at the trailing end side. In this manner, all welds 10 of a main coolant line 4 can be tested in just a single underwater operation.

1. A method for testing an annular weld of a main coolant line connected to a reactor pressure vessel of a nuclear power plant, the method comprising the following steps:
providing a self-propelled submersible vehicle having ends and test devices each disposed at a respective one of the ends for positioning at an inner circumferential surface of the main coolant line and movement in circumferential direction of the main coolant line;
introducing the submersible vehicle into an opened and flooded reactor pressure vessel;
guiding the submersible vehicle into a flooded main coolant line;
fixing the submersible vehicle in vicinity of a weld by using radially deployable spreading arms; and
subsequently positioning one of the test devices at the weld and moving the test device along the weld in circumferential direction.

2. The method according to claim 1, which further comprises:
fixing the submersible vehicle with the spreading arms in a linear section of the main coolant line and an end side of the submersible vehicle having the test device facing the weld; and
testing a weld used to weld end sides of an elbow-shaped section of the main coolant line to the linear section of the main coolant line.

3. The method according to claim 1, which further comprises mounting the test devices on the submersible vehicle for rotatation about a central longitudinal axis disposed perpendicular to the end sides of the submersible vehicle and for radial deployment perpendicular to the central longitudinal axis.

4. An apparatus for testing annular welds of a main coolant line connected to a reactor pressure vessel of a nuclear power plant, the apparatus comprising:
a self-propelled submersible vehicle having a base body and end sides;
a plurality of radially deployable spreading arms disposed at said base body for fixing said submersible vehicle in the main coolant line; and
test devices each disposed at a respective one of said end sides of said submersible vehicle, said test devices configured to be positioned at an inner circumferential surface of the main coolant line and moved in circumferential direction of the main coolant line.

5. The apparatus according to claim 4, wherein said submersible vehicle has a central longitudinal axis perpendicular to said end sides of said submersible vehicle, and at least one of said test devices is mounted on said submersible vehicle for rotatation about said central longitudinal axis and for radial deployment perpendicular to said central longitudinal axis.

6. The apparatus according to claim 4, wherein said submersible vehicle has a central longitudinal axis perpendicular to said end sides of said submersible vehicle, and said spreading arms are each disposed in a respective one of two mutually spaced-apart spread planes orientated perpendicularly to said central longitudinal axis.

7. The apparatus according to claim 5, wherein said spreading arms are each disposed in a respective one of two mutually spaced-apart spread planes orientated perpendicularly to said central longitudinal axis.

8. The apparatus according to claim 6, wherein said plurality of spreading arms includes three spreading arms in each respective one of said spread planes.

9. The apparatus according to claim 7, wherein said plurality of spreading arms includes three spreading arms in each respective one of said spread planes.

10. The apparatus according to claim 5, which further comprises at least one inspection camera disposed at least at one of said end sides of said submersible vehicle, said at least one inspection camera being rotatable about said central longitudinal axis and mounted to pivot about a pivot axis orientated perpendicularly to said central longitudinal axis.

11. The apparatus according to claim 6, which further comprises at least one inspection camera disposed at least at one of said end sides of said submersible vehicle, said at least one inspection camera being rotatable about said central longitudinal axis and mounted to pivot about a pivot axis orientated perpendicularly to said central longitudinal axis.

12. The apparatus according to claim 7, which further comprises at least one inspection camera disposed at least at one of said end sides of said submersible vehicle, said at least one inspection camera being rotatable about said central longitudinal axis and mounted to pivot about a pivot axis orientated perpendicularly to said central longitudinal axis.

13. The apparatus according to claim 8, which further comprises at least one inspection camera disposed at least at one of said end sides of said submersible vehicle, said at least one inspection camera being rotatable about said central longitudinal axis and mounted to pivot about a pivot axis orientated perpendicularly to said central longitudinal axis.

14. The apparatus according to claim 9, which further comprises at least one inspection camera disposed at least at one of said end sides of said submersible vehicle, said at least one inspection camera being rotatable about said central longitudinal axis and mounted to pivot about a pivot axis orientated perpendicularly to said central longitudinal axis.
